(19) United States
(12) Patent Application Publication
(10) Pub. No.: US 2012/0316711 A1
(43) Pub. Date: Dec. 13, 2012

(54) COOLING SYSTEM WITH ANOMALY DETECTION

(75) Inventors: Donald J. Christian, Fremont, CA (US); Ali Maleki, Canton, MI (US); Dan Schum, Lake Balboa, CA (US)

(73) Assignee: Coda Automotive, Inc., Los Angeles, CA (US)

(21) Appl. No.: 13/155,820

(22) Filed: Jun. 8, 2011

(51) Int. Cl. B60K 11/00; F28F 27/00

(52) U.S. Cl. 701/22; 165/200

(57) ABSTRACT

A cooling system is provided for cooling electronics and/or other heat sources using a liquid coolant. The cooling system may be provided with a detection arrangement to detect cooling anomalies, including gas bubbles or pockets and/or contaminants in the coolant, that could potentially reduce the cooling efficiency of the system. The cooling system includes a pump for moving or circulating a liquid coolant through the system. The detection arrangement may be arranged to monitor the speed of the pump and identify overspeed and/or underspeed events when the pump speed exceeds or is below a predetermined threshold speed or setpoint. The duration and/or number of detected events may be indicative of the presence of an anomaly with the system. The system may include one or more indicators that provide an indication of the operating condition of the cooling system based on the magnitude of the detected events.

### FIELD

The present invention relates to a cooling system, and more particularly, to an electronic cooling system provided with anomaly detection.

### BACKGROUND

Electronic devices and systems generate heat that generally needs to be dissipated in some manner to reduce potential degradation, damage or failure of the device or system due to an over-temperature or overheat condition. The particular cooling scheme or arrangement employed for cooling electronic devices or systems may depend on the amount of heat being generated by the device or system. For example, a low-power system may be adequately cooled using a passive cooling scheme, whereas a high-power system may utilize an active cooling arrangement which dissipates heat using forced air or liquid coolant.

The sensitivity of electronic devices, such as semiconductor devices, to high temperature can present thermal management issues for high-power applications, such as electrically-propelled and hybrid-electrically-propelled vehicles. For example, heat exposure can cause various failure mechanisms, including dielectric breakdown and electro-migration of metals, particularly aluminum interconnect lines. Peak temperature and the duration of heat exposure are several factors that can impact reliability of electronic devices.

For high power applications, it may be desirable to employ a liquid-based cooling system to dissipate the large amount of heat being generated by the electronic devices or system. An anomaly associated with the liquid coolant may impact the cooling ability of the system. For example, with liquid-cooled systems, air or gas bubbles and/or contaminants may potentially be formed or introduced into the liquid coolant. If present, bubbles can potentially impact the efficiency of the cooling system by creating localized regions of reduced heat transfer to the coolant. Contaminants, if present, may create potential blockages or create pump friction that can potentially reduce coolant flow. Such anomalies can present potential challenges when cooling an electronic system due to the high concentration of heat that can be generated by electronic devices. Any potential impact to the cooling efficiency may depend on the size and/or number of bubbles or contaminants being carried through the system by the coolant.

### BRIEF SUMMARY

In one illustrative embodiment, a cooling system is provided for cooling a heat source that generates heat during operation. The cooling system comprises a heat exchanger adapted to be fluidly coupled to the heat source, a pump adapted to move a liquid coolant through the cooling system for carrying heat from the heat source to the heat exchanger, and a controller adapted to monitor pump speed and determine presence of an anomaly with the cooling system based on pump overspeed events and/or pump underspeed events.

In another illustrative embodiment, a cooling system is provided for an electric automobile that includes electronics for operating the automobile. The cooling system comprises a coolant pump adapted to move a liquid coolant through the cooling system for removing heat generated by the electronics, and a controller adapted to monitor pump speed and determine presence of an anomaly associated with the coolant based on pump overspeed events and/or pump underspeed events.

In another illustrative embodiment, an electric vehicle comprises electronics for operating the electric vehicle and a cooling system for cooling the electronics. The cooling system includes a coolant pump adapted to move a liquid coolant through the cooling system for removing heat generated by the electronics, and a controller adapted to monitor pump speed and determine presence of an anomaly with the cooling system based on pump overspeed events and/or pump underspeed events.

In a further illustrative embodiment, a method is provided for detecting an anomaly with a cooling system. The method comprises acts of (a) monitoring pump speed of a coolant pump that moves a liquid coolant through the cooling system, (b) detecting one or more pump overspeed events when the pump speed exceeds a first speed threshold and/or one or more pump underspeed events when the pump speed is below a second speed threshold, the first speed threshold being greater than the second speed threshold; and (c) determining presence of an anomaly associated with the coolant based on the pump overspeed events and/or the pump underspeed events.

In another illustrative embodiment, a method is provided for detecting an anomaly in a cooling system for an electric vehicle. The method comprises acts of (a) monitoring a coolant pump for pump overspeed and/or underspeed events that occurs when pump speed exceeds or is below one or more speed thresholds while moving a liquid coolant through the cooling system; and (b) detecting an anomaly with the cooling system based on the magnitude of pump overspeed events and/or pump underspeed events that occur during operation of the coolant pump.

### BRIEF DESCRIPTION OF DRAWINGS

Various embodiments of the invention will now be described, by way of example, with reference to the accompanying drawings, in which:

FIG. 1 is a schematic view of a cooling system according to one illustrative embodiment;

FIG. 2 is a schematic illustration of an electronic device that may be cooled with the cooling system;

FIG. 3 is a schematic view of a cooling system controller according to one illustrative embodiment;

FIG. 4 is a graphical representation of operation of the cooling system with bubble detection; and

FIG. 5 is a schematic view of a cooling/heating system for an electric automobile according to another illustrative embodiment.

### DETAILED DESCRIPTION

A cooling system is provided for cooling electronics, including high power electronics or electrically-driven devices, and/or other heat sources using a liquid coolant. The cooling system may be provided with a detection arrangement to detect gas bubbles or pockets in the coolant that could potentially reduce the cooling efficiency of the system and contribute to an elevated temperature for the electronics. If desired, the detection arrangement may also be configured to detect other events, including contaminants in the coolant, that could potentially reduce the cooling efficiency of the system.

In one embodiment, the cooling system includes a pump for moving or circulating a liquid coolant through the cooling system for carrying away heat generated by the electronic devices and/or other heat sources. The heated coolant may be circulated to a heat exchanger or radiator which disperses or transfers the heat to the ambient environment.

According to one aspect, the system may be arranged to monitor the speed of the pump and identify an overspeed event when the pump speed exceeds a predetermined threshold speed and/or an underspeed event when the pump speed falls below a minimum speed setpoint. The duration and/or number of overspeed and/or underspeed events may be indicative of a cooling system anomaly, including one or more gas bubbles or pockets circulating in the coolant, contaminants in the coolant, or potential mechanical, electrical or software problems associated with the cooling system.

According to one aspect, the system may be configured to provide one or more system status signals that are indicative of the operating condition or status of the cooling system based on the level or severity of the detected events. One or more indicators may be provided to present a visual and/or audible indication of cooling system status in response to the system status signals.

According to one aspect, a controller may be operatively coupled to the pump to set one or more target operating speeds, such as minimum and maximum speeds, and/or monitor operation of the pump. The controller may monitor a signal from the pump that is indicative of the actual pump speed. The controller may be configured or programmed to detect overspeed events, which may occur when one or more gas bubbles or pockets pass through the pump during pump operation. The controller may be configured or programmed to detect underspeed events, which may occur due to contaminants in the coolant or other anomalies with the cooling system. The controller may store the detected events in memory. The stored information may include a measure of the event's severity along with the date and time of the event, if desired.

According to one aspect, the controller may be configured or programmed to sample the pump speed at a set time interval for a predetermined period of time. The controller may be configured or programmed to store the speed samples within a rolling window of fixed duration. The controller may be configured or programmed to determine the potential impact of bubbles or contaminants in the coolant based on the number of overspeed and/or underspeed events, if any, present or stored in the sample window at any particular time. In this manner, the controller may provide a time filter scheme or arrangement for detecting bubbles, contaminants and/or other potential anomalies with the cooling system.

A large number of detected overspeed and/or underspeed events present or stored within the sample window may provide a prognostic indication of a potential overheat condition associated with the cooling system. In this manner, use of an active, self-monitoring detection arrangement may enhance the performance and/or reliability of the cooling system. Such an arrangement may provide early detection of potential threats to the cooling system caused by gas bubbles or pockets, coolant contaminants and/or other anomalies, and allow prognosis of situations that may lead to a potential overheat condition.

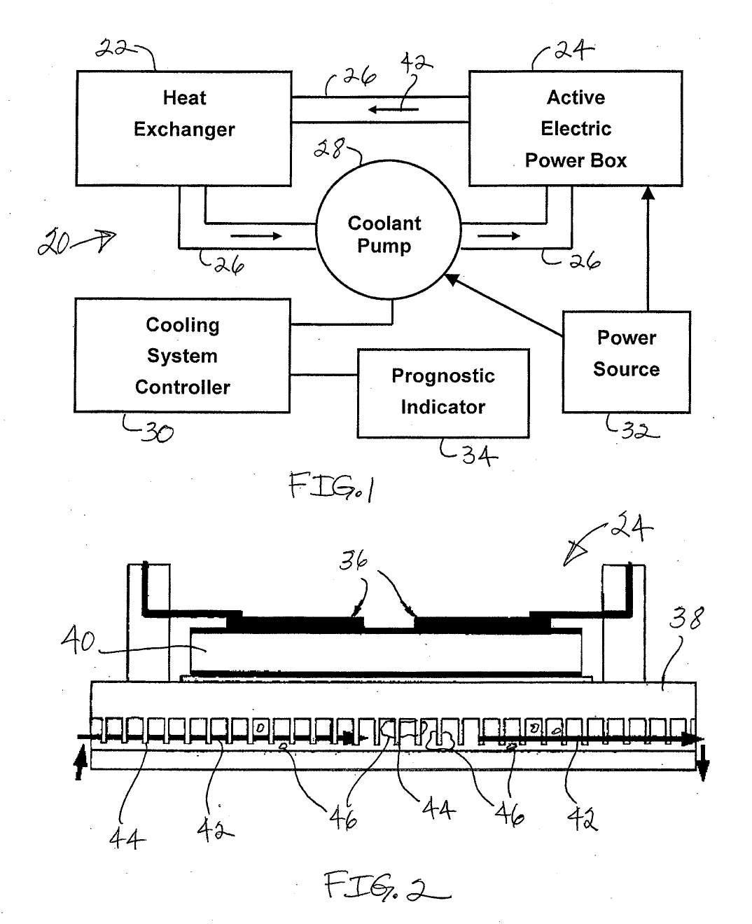

In one illustrative embodiment shown in FIG. 1, the cooling system 20 may include a heat exchanger or radiator 22 that is fluidly coupled to one of more heat sources 24, including electronic or electrically-driven devices which may generally be referred to as electronics. The heat exchanger 22 may be fluidly coupled to the heat sources 24, which are to be cooled, with one or more conduits 26 suitably arranged for the particular application. The conduits 26 may include any desirable arrangement of pipes, hoses and/or ducts apparent to one of skill in the art for conveying a liquid coolant through the system.

The cooling system may include a coolant pump 28 to move or circulate a coolant through the system, including the heat exchanger and the electronics, via the conduits. A system controller 30 may be provided to control and monitor pump speed. A power source 32 may be provided to supply electrical power to the pump and/or electronics. The system may include one or more indicators 34 to provide an indication of the cooling status of the system.

In one embodiment for an automotive application, the power source may include a battery of an automotive motor-alternator. In another embodiment for stationary cooling applications, the power source may include a shared power bus system or an external power grid. However, it is to be understood that any suitable power source may be employed as should be apparent to one of skill in the art.

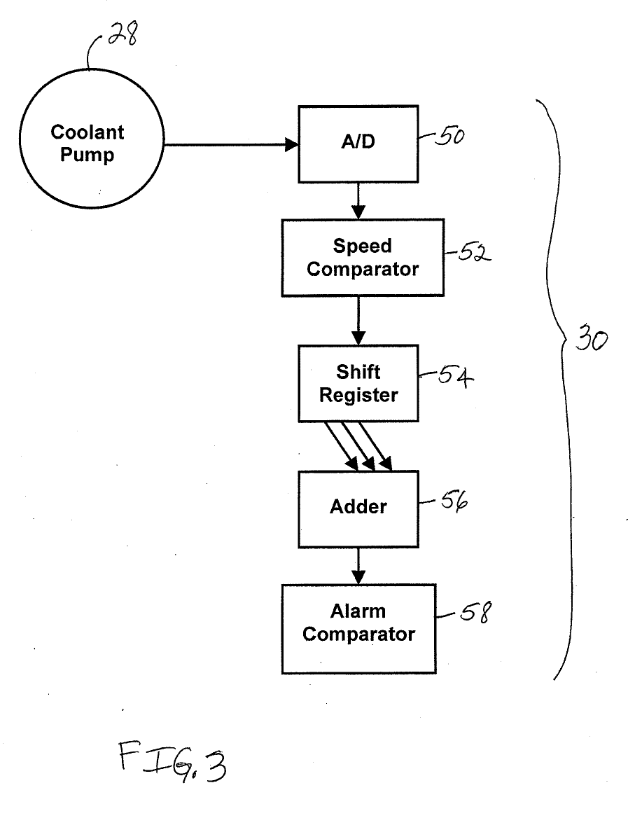

FIG. 2 illustrates an example of an electronic device 24 that may be cooled with the cooling system. As illustrated, the electronic device 24 may include one or more semiconductor die 36 that generate heat during operation. The die 36 may be mounted to a cold plate 38, such as a copper plate. The die 36 may be electrically insulated from the cold plate 38 with an insulating layer 40. Heat generated by the die 36 is conducted through the insulating layer 40 and into the cold plate 38 which is cooled by the liquid coolant 42 being circulated through the cooling system. As shown, the cold plate 38 may include an arrangement or array of cooling fins or pins 44 that enhance the transfer of heat from the cold plate to the coolant.

The passage of gas bubbles 46 or pockets through the cold plate 38 may potentially reduce the effectiveness of the heat transfer to the coolant 42 and may depend upon the number and size of such bubbles and pockets. When cooling relatively small electronic devices, bubbles may potentially become trapped by the cooling fins or pins 44 of the cold plate 38 and thereby create a dam effect that could reduce or limit the passage of a liquid coolant through the cold plate.

The presence of contaminants, such as sand or rust particles, in the coolant may potentially obstruct coolant flow or create friction that reduces pump speed. A reduction in pump speed may reduce the amount of coolant flowing through the cold plate.

The semiconductor device may include one or more microprocessors, digital logic and switches, power diodes, and transistors such as MOSFETs (metal oxide semiconductor field effect transistors) and IGBTs (insulated gate polar transistors). However, it is to be appreciated that the cooling system may be employed to cool any type of electronic device and/or other heat source that would benefit from liquid cooling as should be apparent to one of skill in the art.

In one embodiment illustrated in FIG. 1, the system may include a system controller or microprocessor 30 that is programmed with a sensorless algorithm to control the speed of the pump motor as should be apparent to one of skill in the art. The motor speed may be reported by a pulse width modulated (PWM) signal having a frequency that is indicative of the actual pump speed. For example, a relatively high frequency would be indicative of a relatively high pump speed, and a relatively low frequency would be indicative of a relatively low pump speed.

In one embodiment, the controller 30 may be set to a constant torque demand. When presented with a consistent or uniform coolant load, which may be determined by fluid viscosity, fluid temperature and flow resistance, the pump 28 produces a steady flow rate of coolant through the cooling system.

In one embodiment, the pump 28 may include an electromagnetically driven impeller pump. The pump may include a rotor magnet that is attached to a plastic impeller. Applying current to the pump motor creates a magnetic field which rotates the impeller to generate pressure for moving the coolant through the cooling system.

In one embodiment, the cooling system may include a pump motor manufactured by Buehler, Inc., model no. AWP 50W. However, it is to be appreciated that other suitable pumps or pump motors apparent to one of skill in the art may be employed with the cooling system.

The cooling system may normally be sealed to reduce or prevent the potential introduction of contaminants. In one embodiment, the cooling system is arranged to circulate liquid coolant in a closed or isolated loop that is normally sealed from the outside environment in a manner apparent to one of skill in the art.

The heat generated by normal momentary power surges in the electronics may lead to local boiling or vaporization of the coolant. Such power surges may result in the formation of gaseous vapor bubbles or gas pockets that may circulate through the cooling system until they condense or are otherwise removed from the coolant. Gas bubbles may also potentially be introduced into the coolant due to leakage or intrusion of foreign material into the cooling system.

The presence of a gas bubble or pocket, which has a lower viscosity than the coolant, may interrupt the steady state operation of the pump. For example, the passage of a gas bubble or pocket through the pump may allow the pump speed to increase in response to the constant torque command and the reduced load on the pump. An overspeed event occurs when the pump speed exceeds a predetermined threshold speed.

The presence of contaminants, such as sand or rust particles, in the coolant may potentially obstruct coolant flow or create friction that reduces pump speed. An underspeed event occurs when the pump speed is below a minimum speed setpoint or threshold.

In one embodiment, the controller 30 may be configured or programmed to detect overspeed events and/or underspeed events and store the detected events in memory. The controller may be configured or programmed to sample the pump speed at a set time interval and to store the speed samples within a rolling window of fixed duration. The controller may be configured or programmed to determine the potential impact of bubbles and/or contaminants in the coolant based on the number of overspeed and/or underspeed events, if any, detected and stored in the sample window at any particular time. When the number of overspeed events and/or underspeed events exceeds a predetermined number, the controller 30 may generate a signal that is sent to one or more indicators 34 which may present a visual and/or audible indication of a potential overheat condition.

A detected overspeed event may represent short term events caused by relatively small gas bubbles passing through the pump, long term events caused by one or more large gas pockets passing through the pump, or a combination of bubbles and pockets that create short and long term events. In this manner, the controller may be configured with a time filter to determine the presence of bubbles.

In one illustrative embodiment shown in FIG. 3, the controller 30 may include an analog-to-digital (A/D) converter 50 that may be configured or programmed to sample the pump speed at a predetermined interval. The sampling process may produce a discrete integer that corresponds to the pump speed. In one embodiment, the integer may range from 0 to 25,000.

As illustrated, the controller 30 may include a speed comparator 52 which may be configured or programmed to receive each discrete integer from the A/D converter 50 and compare the integer against one or more setpoints or thresholds. In one embodiment, the speed comparator 52 may be provided with a high setpoint and a low setpoint. In another embodiment, the speed comparator may have one setpoint or speed threshold, such as a high setpoint or maximum speed threshold. If desired, the comparator may include three or more setpoints or thresholds.

The speed comparator 52 may be configured or programmed to generate a flag based on the discrete integer for each speed sample. In one embodiment, the flag may be either zero (0) or one (1) based on the sampled pump speed.

For applications where it may be desirable for the pump to operate within a desired range of pump speed, the speed comparator 52 may have high and low setpoints that correspond to the desired range of pump speed. In one embodiment, the speed comparator 52 may generate a zero (0) flag when the discrete integer for the speed sample falls within the set range defined by the low and high setpoints. When the discrete integer for the speed sample falls outside the set range, either below the low setpoint or above the high setpoint, the speed comparator may generate a one (1) flag.

For applications where it may be desirable to identify pump overspeed conditions, such as may occur due to the presence of bubbles, the speed comparator 52 may have a high setpoint or maximum speed threshold. In one embodiment, the speed comparator 52 may generate a zero (0) flag when the discrete integer for the speed sample is at or below the speed threshold. When the discrete integer for the speed sample exceeds the high setpoint or speed threshold, the speed comparator may generate a one (1) flag.

As illustrated, the controller 30 may include a shift register 54 that has a discrete number of memory positions for storing the flags generated by the speed comparator 52. In one embodiment, the shift register 54 may include thirty (30) discrete memory positions that each stores a single flag generated for each speed sample. When the shift register is full, a new flag is stored at each interval and the oldest flag is deleted from the register. Thus, for a register with thirty memory positions, any flag older than thirty sample intervals will be deleted from the register. It is to be understood that the shift register may include any number of memory positions suitable for a particular application as should be apparent to one of skill in the art.

As illustrated in FIG. 3, the controller 30 may include an adder 56 that is configured or programmed to add up the value of the flags stored in the shift register. In one embodiment, the total sum of flag values may range from a minimum of 0 to a maximum of 30 for a register having thirty memory positions. The sum of the adder 56 may be fed to an alarm comparator 58 where the sum may be evaluated against one or more setpoints to determine the operating condition of the cooling system. In one embodiment, the alarm comparator 58 may be configured or programmed with two setpoints that may correspond to “warning” and “alarm” conditions.

In one illustrative embodiment, the cooling system 20 may operate with a steady-state pump speed of approximately 3500 to 5000 RPM under normal operating conditions with the pump primed and fully engaged with the coolant. The system may be configured to have a high setpoint or maximum speed threshold of 15,000 RPM, such that any detection of a pump speed exceeding the threshold speed will be identified as an overspeed event. If desired, the system may be configured to also have a low setpoint or minimum speed threshold of 1,000 RPM, such that any detection of pump speed lower than the low setpoint will be identified as an underspeed event. It is to be appreciated that the cooling system may be configured to operate the pump with any suitable steady-state speed and set any suitable setpoints or threshold speeds as should be apparent to one of skill in the art.

In one illustrative embodiment, the controller 30 may be programmed to sample the pump speed at an interval of 10 milliseconds. As described above, the samples are stored in memory and are analyzed within the shift register 54. Once the register is full, the oldest sample is dropped from the register as a new sample is added to the register. In one embodiment described above, the shift register 54 may store thirty samples of pump speed that are available at any particular time to determine the level of gas bubbles or pockets present in the coolant. However, it is to be understood that the pump speed may be sampled at any interval or frequency and/or the shift register may be configured to store any number of samples that are suitable for a desired application as should be apparent to one of skill in the art.

In one illustrative embodiment, a normal or green operating condition may exist when the number of detected overspeed and/or underspeed events within the shift register 54 ranges from 0 to 5. A subcritical or yellow operating condition may be identified when the number of detected overspeed and/or underspeed events within the shift register ranges from 6 to 11. In such a situation, a “warning” condition may be signaled by the alarm comparator 58. A critical or red operating condition may be identified when the number of detected overspeed and/or underspeed events within the shift register exceeds 11. In such a situation, an “alarm” condition may be signaled by the alarm comparator. It is to be understood that the operating condition of the cooling system may be determined using any suitable ranges or thresholds for the number of detected overspeed and/or underspeed events as should be apparent to one of skill in the art.

Several non-limiting examples of pump speed samples monitored by the controller 30 are described below. Each example illustrates flags stored in each memory location of the shift register 54 that are evaluated by the adder 56 and alarm comparator 58 of the controller to determine the operating condition or status of the system.

### Example 1

| 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 0 | 0 |

| 17 | 18 | 19 | 20 | 21 | 22 | 23 | 24 | 25 | 26 | 27 | 28 | 29 | 30 | Sum | Status |
|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 0 | OK |

In this example, the shift register 54 contains all zero (0) flags generated by the speed comparator 52 during the thirty most recent samples taken by the A/D converter 50. During this period, the controller has detected no overspeed or underspeed events with the pump. The system status is identified as a normal or green operating condition.

### Example 2

| 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| 0 | 1 | 0 | 0 | 0 | 0 | 0 | 0 | 1 | 0 | 0 | 0 | 0 | 0 | 0 | 0 |

| 17 | 18 | 19 | 20 | 21 | 22 | 23 | 24 | 25 | 26 | 27 | 28 | 29 | 30 | Sum | Status |
|---|---|---|---|---|---|---|---|---|---|---|---|---|---|---|---|
| 0 | 0 | 0 | 0 | 0 | 0 | 0 | 0 | 0 | 0 | 0 | 0 | 0 | 0 | 2 | OK |

In this example, the shift register 54 contains two one (1) flags generated by the speed comparator 52 during the thirty most recent samples taken by the A/D converter 50. During this period, the sum is evaluated and determined to be below the “warning” setpoint. Thus, the system status is identified as a normal or green operating condition.

### Example 3

| 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| 0 | 0 | 0 | 0 | 0 | 0 | 0 | 0 | 1 | 1 | 1 | 0 | 1 | 1 | 1 | 1 |

| 17 | 18 | 19 | 20 | 21 | 22 | 23 | 24 | 25 | 26 | 27 | 28 | 29 | 30 | Sum | Status |
|---|---|---|---|---|---|---|---|---|---|---|---|---|---|---|---|
| 0 | 0 | 0 | 0 | 0 | 0 | 0 | 0 | 0 | 0 | 0 | 0 | 0 | 1 | 8 | Warning |

In this example, the shift register 54 contains eight one (1) flags generated by the speed comparator 52 during the thirty most recent samples taken by the A/D converter 50. During this period, the sum is evaluated and determined to be above the “warning” setpoint, but less than the “alarm” setpoint. Thus, the system status is identified as a subcritical or yellow operating condition.

### Example 4

| 1 | 2 | 3 | 4 | 5 | 6 | 7 | 8 | 9 | 10 | 11 | 12 | 13 | 14 | 15 | 16 |
|---|---|---|---|---|---|---|---|---|---|---|---|---|---|---|---|
| 0 | 0 | 0 | 0 | 0 | 0 | 0 | 0 | 1 | 1 | 1 | 0 | 0 | 0 | 1 | 1 |

| 17 | 18 | 19 | 20 | 21 | 22 | 23 | 24 | 75 | 26 | 27 | 28 | 29 | 30 | Sum | Status |
|---|---|---|---|---|---|---|---|---|---|---|---|---|---|---|---|
| 1 | 1 | 0 | 0 | 1 | 1 | 1 | 1 | 1 | 1 | 1 | 1 | 0 | 0 | 15 | ALARM |

In this example, the shift register 54 contains fifteen one (1) flags generated by the speed comparator 52 during the thirty most recent samples taken by the A/D converter 50. During this period, the sum is evaluated and determined to be above both the “warning” and “alarm” setpoints. Thus, the system status is identified as a critical or red operating condition.

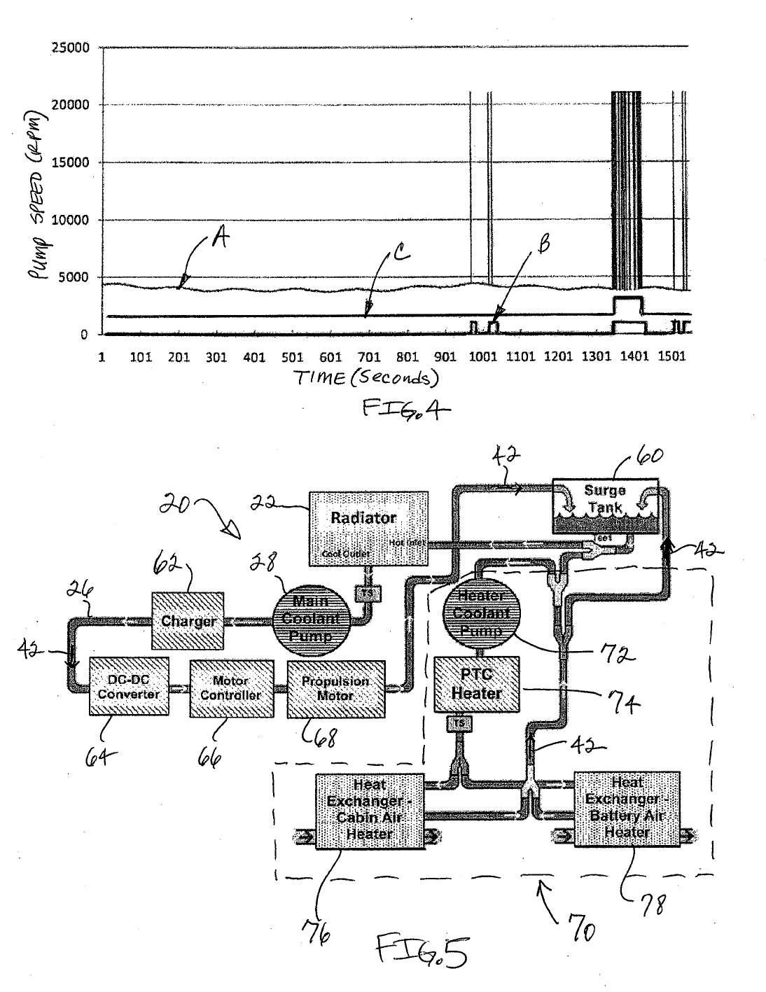

One exemplary embodiment of a cooling system with bubbles circulating in the coolant for cooling electronics is described in connection with FIG. 4.

In FIG. 4, graph A represents pump speed (Y-axis) of the coolant pump being measured over time (X-axis). As shown, the pump is initially operating at a steady-state speed of approximately 3800 RPM which is indicative of the coolant being free of bubbles. During this period, the electronics being cooled may be operated under normal conditions.

At approximately 950 seconds, several overspeed events are detected when the pump speed exceeds a speed threshold of 15,000 RPM. As illustrated, the pump speed momentarily peaks at approximately 21,000 RPM. These events correspond to several small bubbles passing through the pump. Detection of these bubbles may be classified as subcritical or subclinical and may raise a diagnostic trouble code (DTC) that is stored in the controller memory. Such events are also detected again at approximately 1500 seconds.

At approximately 1350 seconds, a significant number of overspeed events are detected over a relatively short period of time. These events correspond to several larger bubbles or pockets passing through the pump. Detection of these events may be classified as critical for being of a sufficient magnitude to potentially impact the operation of the cooling system. Detection of these events may be communicated to the operational electronics as an indication that operation of the electronics being cooled should be restricted to avoid potential damage.

In FIG. 4, graph B represents signals that correspond to the detection of subcritical or subclinical conditions with the cooling system. These signals may provide an early warning indicator for the cooling system that precede symptoms of potential cooling problems. These events may be latched into the memory of the pump controller as a DTC and may be displayed as a service indicator. When such an indicator or DTC is present, the cooling system may be checked for low coolant level or contamination in the fluid.

In FIG. 4, graph C represents a signal that corresponds to the detection of a critical condition with the cooling system. Such a signal may provide a warning indicator that use of the electronic devices being cooled should be immediately restricted to reduce a potential overheat condition. For vehicle applications, this signal may activate an indicator, such as a “check engine” lamp, to warn of a potential cooling system failure that requires immediate attention.

The cooling system of the present invention may be particularly suitable for an automotive application. In one embodiment, aspects of the cooling system may be utilized with an electric automobile. However, it is to be understood that the cooling system is not limited for use with an electric automobile and may be used for other applications apparent to one of skill in the art.

In one illustrative embodiment shown in FIG. 5, an electric vehicle may be provided with an electronic cooling system 20 that is similar to the cooling system described above. As shown, a fluid coolant 42 may be pumped from a radiator 22 to electronic devices 24 using a first or main coolant pump 28. The coolant removes the heat generated by the electronic devices to maintain the electronics below a desired temperature. After exiting the electronics, the heated coolant is pumped to a surge tank 60 where air or gas bubbles or pockets, if present, may be removed, for example, by floating to the top of the surge tank. Coolant is drawn from the surge tank 60 and pumped to the radiator 22 where heat may be removed from the coolant and dissipated to the atmosphere.

As described above, the coolant pump 28 may be monitored for overspeed events that may be indicative of air or gas bubbles and/or pockets in the coolant. Should the number of detected overspeed events exceed a predetermined amount, one or more indicators 34, such as an “over-temperature” lamp and/or a “check engine” lamp, may be activated to alert the vehicle operator of a potential overheat condition.

A prognostic indicator 34 may also be implemented as a diagnostic trouble code (DTC) is latched digitally and stored in memory of the controller. In one embodiment, each DTC event may be communicated digitally on an optional control area network. Such communication may be independent of the indicator lamps.

The DTC codes may be retrieved at a later time by a service technician or mechanic for use as a guide to troubleshoot or tune the cooling system, for example, using a diagnostic scan tool. If desired, supplementary data, including date and time, and severity or frequency of occurrence over a time interval, may be recorded with each DTC.

During a normal operating condition, an electric automobile may be operated with unrestricted performance. During a subcritical operating condition, the electric automobile may be operated with some performance restrictions due to the presence of some bubbles or contaminants that could impact the efficiency of the cooling system. During a critical operating condition, the electric automobile may be operated with significant performance restrictions due to the presence of a high number of detected bubbles or contaminants that could potentially result in overheat of the electronics were the vehicle allowed to be operated in an unrestricted manner.

As illustrated in FIG. 5, the electronics 24 may include a charger 62, a DC-DC converter 64, a MCM motor controller inverter 66 and a propulsion motor 68. However, it is to be understood that the electronics may include any devices and/or systems that may be implemented in an electronic system for an automobile, including an electric vehicle, as should be apparent to one of skill.

In an electric automobile, there is no waste heat generated by a combustion engine that may be used for climate control of the cabin or to heat the battery compartment. Thus, the vehicle may be provided with a vehicle heating system that is used in conjunction with the electronic cooling system.

In one illustrative embodiment as shown in FIG. 5, a separate heating circuit or loop 70 may be provided to provide heat for the automobile cabin and/or battery compartment. The heating system may include a second or heater coolant pump 72 that circulates a coolant fluid 42 through a heater 74 which is configured to heat the coolant to a desired temperature. Depending on system demand, the heated fluid may then circulated through a cabin air heat exchanger 76 and/or a battery air heat exchanger 78 to heat the cabin air and/or the battery compartment air to a desired temperature.

As illustrated, the heater coolant 42 may be circulated in a closed loop such that coolant exiting the cabin air and battery air heat exchangers may be circulated directly to the heater pump 72. Alternatively, the heater coolant, or at least a portion of the heater coolant, may be directed to the surge tank 60 and mixed with the coolant from the cooling system or loop 20. Any bubbles present in the heating loop 70 may be removed in the surge tank. A portion of the mixed coolant may be directed from the surge tank to the heater pump 72.

For some applications, it may be desirable to configure the system to detect gas bubbles or pockets or contaminants in the heating loop. In one illustrative embodiment, the heating loop 70 may employ a detection arrangement similar to the cooling loop 20 for monitoring the speed of the heater pump 72 to detect bubbles or gas pockets and/or contaminants in the heating coolant.

Although the presence of bubbles in the heating loop may be considered less critical as compared to bubbles in the cooling loop, it may nevertheless be desirable to detect bubbles as a way to determine the overall integrity of the cooling/heating system. For example, bubbles in the heating coolant may be indicative of a leak in the heating system.

A bubble detection system for a cooling and/or heating system of an automobile may be advantageous when manufacturing and/or servicing an automotive vehicle. For example, a bubble detection system may accelerate the coolant fill process by signaling its earliest completion, automatically accommodate variations in cooling/heating system volumes, and/or dynamically detect any potential problems related to the fill cycle.

In one illustrative embodiment, such as during vehicle manufacturing or service, the coolant pump 28 may be engaged before the cooling/heating system of the vehicle is completely filled with coolant fluid. During this period, bubbles may initially be present in the coolant and decrease as the amount of coolant increases and the system reaches its full capacity. When bubbles are no longer detected in the coolant, the controller 30 may provide a signal that is indicative of a full cooling/heating system.

Such an arrangement may accommodate variations in the coolant volume for each vehicle and reduce the incidence of excessive air space or bubbles in the system. Such an arrangement may also detect potential problems that could interfere with a successful fill cycle, including, but not limited to, system leaks, manufacturing flaws, dimensional tolerance stackup, material blemishes, incomplete closure of the system, and assembly errors, such as a kinked hose or the presence of a foreign object in the system.

Although the cooling system 20 has been described above in connection with cooling electronics with a particular application for an electric vehicle, it is to be understood that aspects of the cooling system are not limited to these applications and that other applications are contemplated. Aspects of the system may be useful for airborne, marine and stationary applications. Other applications that may benefit from aspects of a cooling system with bubble or contaminant detection may include, but are not limited to, windmills, hydro-electric generators, blowers for buildings and HVAC systems, air conditioner compressors, heat pumps, pumps for water wells, oil and gas extraction, refining, marine propulsion, and shipboard sump applications. Other electronic cooling applications may include, but are not limited to, high-performance computer electronics, disk drive arrays, server farms, and data centers.

It should be understood that the foregoing description of various embodiments of the invention are intended merely to be illustrative thereof and that other embodiments, modifications, and equivalents of the invention are within the scope of the invention recited in the claims appended hereto.

What is claimed is:

1. A cooling system for cooling a heat source that generates heat during operation, the cooling system comprising:
a heat exchanger adapted to be fluidly coupled to the heat source;
a pump adapted to move a liquid coolant through the cooling system for carrying heat from the heat source to the heat exchanger; and
a controller adapted to monitor pump speed and determine presence of an anomaly with the system based on pump overspeed events and/or pump underspeed events.

2. The cooling system according to claim 1, wherein the controller is configured to determine the anomaly based on a number of pump overspeed and/or underspeed events detected within a period of time.

3. The cooling system according to claim 2, wherein the controller is configured with a first speed threshold and a pump overspeed event occurs when the controller detects a pump speed that exceeds the first speed threshold.

4. The cooling system according to claim 3, wherein the controller is configured with a second speed threshold and a pump underspeed event occurs when the controller detects a pump speed that is below the second speed threshold, the first speed threshold being greater than the second speed threshold.

5. The cooling system according to claim 2, wherein the period of time is a rolling window of time.

6. The cooling system according to claim 2, wherein the controller is configured to monitor the speed of the pump at a fixed interval.

7. The cooling system according to claim 1, further comprising at least one indicator adapted to receive a signal from the controller that is indicative of an operating condition of the cooling system based on a level of the anomaly.

8. The cooling system according to claim 7, wherein the at least one indicator is configured to provide an indication of any one or combination of a normal operating condition, a subcritical operating condition and a critical operating condition.

9. The cooling system according to claim 1, wherein the anomaly includes bubbles within the coolant and the controller is configured to determine presence of bubbles within the coolant based pump overspeed events.

10. The cooling system according to claim 9, wherein the controller is configured to determine a level of bubbles within the coolant based on a number of overspeed events detected within a period of time.

11. The cooling system according to claim 10, further comprising at least one indicator adapted to receive a signal from the controller that is indicative of an operating condition of the cooling system based on the level of the bubbles detected in the coolant.

12. A cooling system for an electric automobile that includes electronics for operating the automobile, the cooling system comprising:
a coolant pump adapted to move a liquid coolant through the cooling system for removing heat generated by the electronics; and
a controller adapted to monitor pump speed and determine presence of an anomaly associated with the coolant based on pump overspeed events and/or pump underspeed events.

13. The cooling system according to claim 12, wherein the anomaly includes bubbles and the controller is configured to determine the level of bubbles within the coolant based on a number of overspeed events detected within a period of time.

14. The cooling system according to claim 13, wherein the controller is configured with a speed threshold and a pump overspeed event occurs when the controller detects a pump speed that exceeds the speed threshold.

15. The cooling system according to claim 13, wherein the period of time is a rolling window of time.

16. The cooling system according to claim 13, wherein the controller is configured to monitor the speed of the pump at a fixed interval.

17. The cooling system according to claim 13, further comprising at least one indicator adapted to receive a signal from the controller that is indicative of an operating condition of the cooling system based on the level of bubbles detected in the coolant.

18. The cooling system according to claim 17, wherein the at least one indicator is configured to provide an indication of any one or combination of a normal operating condition, a subcritical operating condition and a critical operating condition.

19. An electric vehicle comprising:
electronics for operating the electric vehicle; and
a cooling system for cooling the electronics, the cooling system including:
a coolant pump adapted to move a liquid coolant through the cooling system for removing heat generated by the electronics; and
a controller adapted to monitor pump speed and determine presence of an anomaly with the cooling system based on pump overspeed events and/or pump underspeed events.

20. The electric vehicle according to claim 19, wherein the controller is configured to determine the anomaly based on a number of pump overspeed and/or underspeed events detected within a period of time.

21. The electric vehicle according to claim 20, wherein the controller is configured with a first speed threshold and a pump overspeed event occurs when the controller detects a pump speed that exceeds the first speed threshold.

22. The electric vehicle according to claim 21, wherein the controller is configured with a second speed threshold and a pump underspeed event occurs when the controller detects a pump speed that is below the second speed threshold, the first speed threshold being greater than the second speed threshold.

23. The electric vehicle according to claim 20, wherein the period of time is a rolling window of time.

24. The electric vehicle according to claim 20, wherein the controller is configured to monitor the speed of the pump at a fixed interval.

25. The electric vehicle according to claim 19, further comprising at least one indicator adapted to receive a signal from the controller that is indicative of an operating condition of the cooling system based on a level of the anomaly.

26. The electric vehicle according to claim 25, wherein the at least one indicator is configured to provide an indication of any one or combination of a normal operating condition, a subcritical operating condition and a critical operating condition.

27. The electric vehicle according to claim 19, wherein the anomaly includes bubbles within the coolant and the controller is configured to determine presence of bubbles within the coolant based pump overspeed events.

28. The electric vehicle according to claim 27, wherein the controller is configured to determine a level of bubbles within the coolant based on a number of overspeed events detected within a period of time.

29. The electric vehicle according to claim 28, further comprising at least one indicator adapted to receive a signal from the controller that is indicative of an operating condition of the cooling system based on the level of the bubbles detected in the coolant.

30. The electric vehicle according to claim 19, wherein the anomaly includes contaminants within the coolant and the controller is configured to determine presence of contaminants within the coolant based pump underspeed events.

31. A method of detecting an anomaly with a cooling system, the method comprising acts of:
(a) monitoring pump speed of a coolant pump that moves a liquid coolant through the cooling system;
(b) detecting one or more pump overspeed events when the pump speed exceeds a first speed threshold and/or one or more pump underspeed events when the pump speed is below a second speed threshold, the first speed threshold being greater than the second speed threshold; and
(c) determining presence of an anomaly associated with the coolant based on the pump overspeed events and/or the pump underspeed events.

32. The method according to claim 31, wherein act (a) includes taking samples of the pump speed at a fixed interval.

33. The method according to claim 32, wherein act (b) includes analyzing each pump speed sample for a pump overspeed event and/or a underspeed event.

34. The method according to claim 33, wherein act (c) includes adding the number of pump overspeed events and pump underspeed events.

35. The method according to claim 34, wherein act (c) includes determining the presence of an anomaly within the coolant based on the number of pump overspeed events and/or pump underspeed events detected over a period of time.

36. The method according to claim 35, wherein the period of time is a moving window of time.

37. The method according to claim 31, further comprising an act (d) of providing an indication of an operating condition of the cooling system based on the presence of an anomaly within the coolant.

38. The method according to claim 37, wherein act (d) includes providing an indication of any one or combination of a normal operating condition, a subcritical operating condition and a critical operating condition.

39. The method according to claim 31, wherein the anomaly includes bubbles within the coolant.

40. The method according to claim 39, wherein act (c) includes determining a level of bubbles within the coolant based on the number of pump overspeed events detected during a period of time.

41. The method according to claim 40, further comprising an act (d) of providing an indication of an operating condition of the cooling system based on the level of bubbles detected within the coolant.

42. A method of detecting an anomaly in a cooling system for an electric vehicle, the method comprising acts of:
(a) monitoring a coolant pump for pump overspeed and/or underspeed events that occurs when pump speed exceeds or is below one or more speed thresholds while moving a liquid coolant through the cooling system; and
(b) detecting an anomaly with the cooling system based on the magnitude of pump overspeed events and/or pump underspeed events that occur during operation of the coolant pump.

43. The method according to claim 42, wherein act (a) includes monitoring the coolant pump for a pump overspeed event that occurs when the pump speed exceeds a first speed threshold.

44. The method according to claim 43, wherein act (a) includes monitoring the coolant pump for a pump underspeed event that occurs when the pump speed is below a second speed threshold, the first speed threshold being greater than the second speed threshold.

45. The method according to claim 42, wherein act (a) includes taking samples of the pump speed at a fixed interval.

46. The method according to claim 45, wherein act (a) includes analyzing each pump speed sample for a pump overspeed event and/or a underspeed event.

47. The method according to claim 46, wherein act (b) includes adding the number of pump overspeed events and pump underspeed events.

48. The method according to claim 47, wherein act (b) includes determining the presence of an anomaly based on the number of pump overspeed events and/or pump underspeed events detected over a period of time.

49. The method according to claim 48, wherein the period of time is a moving window of time.

50. The method according to claim 42, further comprising an act (c) of providing an indication of an operating condition of the cooling system based on the presence of an anomaly with the cooling system.

51. The method according to claim 50, wherein act (c) includes providing an indication of any one or combination of a normal operating condition, a subcritical operating condition and a critical operating condition.

52. The method according to claim 51, further comprising an act (d) of selectively restricting operation of the electric vehicle in response to a subcritical operating condition or a critical operating condition.

53. The method according to claim 42, wherein the anomaly includes presence of bubbles within the coolant.

54. The method according to claim 53, wherein act (b) includes determining a level of bubbles within the coolant based on the number of pump overspeed events detected during a period of time.

55. The method according to claim 54, further comprising an act (c) of providing an indication of an operating condition of the cooling system based on the level of bubbles detected within the coolant.
